(19) United States
(12) Patent Application Publication
(10) Pub. No.: US 2008/0010405 A1
(43) Pub. Date: Jan. 10, 2008

(54) SELECTABLE PROFILES AND ACTIONS FOR REMOVABLE MEMORY DEVICES

(75) Inventors: Lloyd W. Allen, Cary, NC (US); Jana Helton Jenkins, Raleigh, NC (US); Steven Michael Miller, Cary, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/456,329

(22) Filed: Jul. 10, 2006

(51) Int. Cl. G06F 12/00

(52) U.S. Cl. 711/115

(57) ABSTRACT

An invention is disclosed for creating selectable user profiles and associated actions for removable computer and/or electronics system memory devices. Specifically, a device, method and system are disclosed for using a software application to create and use selectable data profiles for information contained in a removable portable memory device, so that a user can select one or more profile(s) for the purpose of performing ensuing actions on the information defined by each selected profile.

### TECHNICAL FIELD

This invention relates generally to removable computer and/or electronics system memory devices, and specifically to a device, method and system for creating selectable data profiles for information contained in a removable portable memory device, so that a user can select a profile in order to perform ensuing actions on the information defined by the profile.

### BACKGROUND

Today the use of many different types of consumer electronics and computer products incorporating removable memory devices is proliferating; including with personal computers (PCs), cellular telephones, digital cameras and portable video player/recorders using compact disk (CD) and/or digital video disk (DVD) technology, and portable digital music (such as ipod® and MP3®) players. It is not unusual for a person to have more than one such product incorporating a portable memory device, or for each member of the family to own one or more such products.

Because of this widespread and common use, it is not unusual for a user to have such problems as failing to remember the specific information (e.g., music, picture, video or computer files) stored on such a memory device; or to have retained “old” data on the device that prevents “new” data from being stored on (or “written to”) it because the device memory capacity is fully utilized; or to inadvertently “lose” data by deleting a file that was not originally recognized as important but was later realized to be vital; or to store (i.e. “save”) a new file using the same name as a different file already contained on the device thereby erasing (or “overwriting”) the original information. It is also not unusual to misplace a computerized memory device containing sensitive data or to leave it unattended for a long enough period of time to expose or compromise such data to loss or theft.

To alleviate these problems, this invention provides a device, method and system for creating selectable data profiles that identify and categorize the information contained in removable computer and/or electronics system memory devices, so that a user can select a profile in order to perform ensuing actions on the information defined by the profile. The teachings set forth in prior art such as for example U.S. Pat. Nos. 6,829,747 & 6,776,343 & 6,760,065 & 5,861,918 & 5,600,781 and in U.S. Patent Application Publication Nos. 2005/0265531 & 2002/0082925 (the disclosures of which are all incorporated by reference as if fully set forth herein) do not disclose a removable portable memory device that allows a user to create and select profiles in a way that resolves these types of problems.

### SUMMARY OF THE INVENTION

An invention is disclosed for creating selectable user profiles and associated actions for removable computer and/or electronics system memory devices. Specifically, a device, method and system are disclosed for preferably using a software application to create and use “selectable data profiles” that identify and categorize the information contained in a removable portable memory device, so that a user can select one or more profile(s) in order to perform ensuing actions on the information defined by each selected profile. A user can select from one or more profiles that have been customized for use with a removable portable memory device and can be identified by their user and/or owner and/or type. The control function(s) for each profile present one or more user-selectable actions (or confirmation of a default action by the user) that can be performed on the information defined by the profile, causing the removable memory device to perform the action after its selection or confirmation. The operation(s) that can be performed on data stored in a portable memory device include: “ENCRYPT”, “EMPTY”, “DOWNLOAD”, “DOWNLOAD & EMPTY”, “PRINT”, “SYNCHRONIZE”, “VIEW LABEL”, “VIEW CAPACITY”, etc.

Information or data stored in a removable portable memory device is accessible through use of the operating system of a host computer for management in a manner similar to other computer system memory. However, the information to be stored on the device presents one or more “selectable (programmable) data profile(s)” that can be created and then accessed for use, modification, subsequent storage (or other management) from (or on) either the device or the connected host computer system or both. The removable memory device preferably presents a list (or “menu”) of such “selectable (programmable) data profile(s)” that can be accessed through the user interface of the host computer system or through a display located on the device itself.

If necessary a “hub” can be used to connect a removable portable memory device to a host computer system. If configured with programmable connection ports, the hub can provide the necessary interfacing software to allow input, storage, display and/or retrieval of profiles as well as profile selection and initiation of profile actions by the user. Such a “profile capable” or intelligent device hub can also be designed to function in a “disconnected mode” to allow some limited functions to be performed when a removable memory device is not connected to a computer system. If the intelligent hub is equipped with memory, data can be stored to it for later retrieval by the portable memory device, with aspects of a selectable profile being input, displayed or performed while the hub and/or device is disconnected from a computer or other host device.

A removable portable memory device can allow a profile to be input and selected by internal or external software control or manually through use of buttons or other controls on the hub or device itself. The selectable profile(s) can also be stored on a host computer system by using a software interface to a portable memory device that reproduces the device display on the computer screen. The profile can also be stored in a data memory area of the removable storage device along with the interfacing software program and then be transferred to the host computer upon installation of the memory device to display (and choose) the selectable profile(s) and the action(s) to be performed on them.

The concept exists for assigning an “autoplay” function to operate a removable portable memory device when it is connected to a host computer system. However, this invention provides a novel approach for creating and using “selectable data profiles” and their associated control functions through a control display that shows how the information defined by a profile can be accessed for use or management when the device is connected to a host computer system. The “selectable profile” concept of the invention also allows for downloading of data to or from different storage areas or “folders” along with use of encryption keys, etc. (as more fully described herein).

It is therefore an object of the invention to overcome the disadvantages of the prior art by providing a device, method and system for presenting selectable user profiles and associated actions for removable computer and/or electronics system memory devices, through operation of a software application to create and use “selectable (programmable) data profiles” that identify and categorize the information contained in a removable portable memory device, so that a user can select one or more profile(s) in order to perform ensuing management actions on the information defined by each selected profile that can be accessed through a list (or “menu”) presented by the user interface of a host computer operating system or by a control display located on the device itself.

It is another object of the invention to overcome the disadvantages of the prior art by providing a device, method and system for presenting selectable user profiles and associated actions for removable computer and/or electronics system memory devices, so that a user can select from one or more profiles that have been customized for use with a removable portable memory device and can be identified by their user and/or owner and/or type, such that the control function(s) for each profile present one or more user-selectable actions (or confirmation of a default action by the user) that can be performed on the information defined by the profile, causing the removable memory device to perform the action after its selection or confirmation.

It is another object of the invention to overcome the disadvantages of the prior art by providing a device, method and system for presenting selectable user profiles and associated actions for removable computer and/or electronics system memory devices, through operation of a “hub” optionally used to connect a removable portable memory device to a host computer system that provides interfacing software to allow input, storage, display and/or retrieval of profiles as well as profile selection and initiation of profile actions by the user, and can function in a “disconnected mode” to allow some limited functions to be performed when a removable memory device is not connected to a computer system, such as profile input, display, deletion, and/or data storage for later retrieval by the portable memory device.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is an illustration of a removable computer and/or electronics system memory device of the present invention.

FIG. 2 is an illustration of a removable computer and/or electronics system memory device of the present invention as installed in a hub device.

FIG. 3 is an illustration of a removable computer and/or electronics system memory and hub device of the present invention as connected to a host computer.

### DETAILED DESCRIPTION OF THE PREFERRED EMBODIMENTS

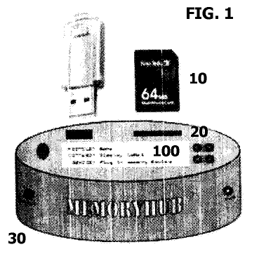

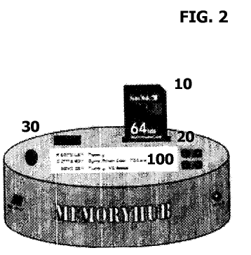

FIGS. 1 through 3 are an illustration of a removable computer and/or electronics system memory device 10 of the present invention. Information or data stored in a removable portable memory device 10 is accessible through use of the operating system of a host computer 1 for management in a manner similar to other computer system memory. However, the information to be stored on the device 10 presents one or more “selectable (programmable) data profile(s)” 100 that can be created and then accessed for use, modification, subsequent storage (or other management) from (or on) either the device 10 or the computer system 1 or both. The removable memory device 10 preferably presents a list (or “menu”) of such “selectable profiles” 100 after it is inserted into a Universal Serial Bus (USB) or other appropriate data drive or port 20 (as shown in FIG. 2) used for sending (or “writing”) or retrieving (“reading”) stored (or “downloaded”) information to (or from) the device. This menu can be accessed through the user input (or “interface”) such as a graphical user interface (GUI) of the computer system 1 to which the portable memory device 10 is connected, or through a light emitting diode (LED) or other display located on the device itself.

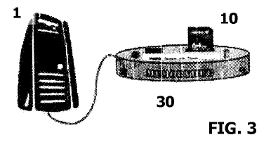

If necessary a “hub” 30 can be used to connect a removable portable memory device 10 to a host computer system 1 (as shown in FIG. 3). If configured with programmable connection ports, the hub 30 can provide the necessary interfacing software to allow input, storage, display and/or retrieval of profiles as well as profile selection and initiation of profile actions by the user. Such a “profile capable” hub 30 can also be designed to function in a “disconnected mode” to allow some limited functions to be performed when a removable memory device 10 is not connected to a computer system; including erasure of files and viewing of remaining storage capacity and/or identification labels for stored files and/or profiles, etc. If the hub 30 is equipped with memory, data can be stored to it for later retrieval by the portable memory device 10, with aspects of a selectable profile 100 being input, displayed or performed while the hub 30 and/or device 10 is disconnected from (or this can be done later when they are connected to) a computer or other host device.

A removable portable memory device 10 and/or hub 30 can allow a profile 100 to be input and selected by internal or external software control or manually through use of buttons or other controls on the hub or device itself. The controls can allow a user to manually switch through a set of profiles or can alternately permit use of automatic detection of profiles (such as with control by a confirmation display). The selectable profile(s) 100 can also be stored on a host computer system 1 by using a software interface to a portable memory device 10 that reproduces the device LED window (or other display) by simulating it in a GUI window (or otherwise) on the computer screen. The profile 100 can also be stored in a data memory area of the removable storage device 10 along with the interfacing software program. This program can then be transferred to the host computer 1 upon installation of the memory device 10 and run via automatic initiation (“autoplay”) to display (and choose) the selectable profile(s) 100 (and the action(s) to be performed on them) using a GUI window or other display.

A user can select from one or more profiles 100 that have been customized for use with a removable portable memory device 10 and can be identified by their user and/or owner and/or type, i.e., “MOM, DAD, TOMMY, SUZY, OLD MUSIC, FUNKY VIDEOS”, etc. The control function(s) for each profile 100 present one or more user-selectable actions (or confirmation of a default action by the user) that can be performed on the information defined by the profile, causing the removable memory device 10 to perform the action after its selection or confirmation. The operation(s) that can be performed on data stored in a portable memory device 10 include: “ENCRYPT”, i.e, downloading unsecured (“unencrypted”) data by erasing it from the memory device and then “encrypting” (or securing the data against unauthorized access) and storing the encrypted data back onto the device; “EMPTY”, i.e., erasing all data from the device; “DOWNLOAD”, i.e., copying all data from the device to another system location or device while leaving the original contents intact; “DOWNLOAD & EMPTY”, i.e., “downloading” all data (as previously described) and then erasing it from the device. “PRINT”, i.e., sending the data contained on the device to a printer for output; “SYNCHRONIZE”, i.e., coordinating the timing of device operation with that of other system components in order to transfer data to or from the device; “VIEW LABEL”, i.e., permitting user viewing of identification labels for stored files and/or profiles; “VIEW CAPACITY”, i.e., permitting user viewing of remaining storage capacity of a device, etc.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A removable portable memory device for use with a computer or electronics system and comprised of the following components acting in cooperation with each other to present one or more programmable data profiles that identify and categorize at least some of the information stored in the memory device for selection by a user of the device:
(a). at least one memory area configured for storing one or more profiles that have been customized for use with the device and are identified by a user or data type; and
(b). at least one control configured for presenting one or more user-selectable actions or default actions to be performed by the memory device on the information defined by the profile;
wherein a user selects one or more profiles to perform ensuing management actions on the information defined by each selected profile.

2. The removable portable memory device of claim 1 further comprised of a hub configured for connecting the memory device to a host computer system through use of a software interface acting in cooperation with the host computer and the hub and the memory device to provide one or more management functions for input, storage, display or retrieval of data or profiles as well as profile selection and initiation of profile actions by the user.

3. The removable portable memory device of claim 2 further comprised of a software application configured for:
(a). creation of one or more selectable programmable data profiles that identify and categorize at least some of the information stored in the memory device; and
(b). selection of a profile by access through a user interface of a host computer operating system or through a control display located on the memory device.

4. The removable portable memory device of claim 3 wherein the device or hub function in a disconnected mode to perform one or more management actions on the information stored in the memory device when the device is not connected to a computer system.

5. The removable portable memory device of claim 3 wherein a profile is selected by use of a list or menu accessed through the user interface or the memory device control display.

6. The removable portable memory device of claim 3 wherein the management actions performed on the data stored in the memory device are selected from a group comprised of encryption, erasure, downloading, printing, synchronization, viewing labels and viewing storage capacity.

7. A computer or electronics system comprised of the following components acting in cooperation with each other to present one or more programmable data profiles that identify and categorize at least some of the information stored in a memory device for selection by a user of the device:
(a). at least one removable portable memory device configured for storing one or more profiles that have been customized for use with the device and are identified by a user or data type; and
(b). at least one control configured for presenting one or more user-selectable actions or default actions to be performed by the memory device on the information defined by the profile;
wherein a user selects one or more profiles to perform ensuing management actions on the information defined by each selected profile.

8. The computer or electronics system of claim 7 further comprised of a hub configured for connecting the memory device to a host computer system through use of a software interface acting in cooperation with the host computer and the hub and the memory device to provide one or more management functions for input, storage, display or retrieval of data or profiles as well as profile selection and initiation of profile actions by the user.

9. The computer or electronics system of claim 8 further comprised of a software application configured for:
(a). creation of one or more selectable programmable data profiles that identify and categorize at least some of the information stored in the memory device; and
(b). selection of a profile by access through a user interface of a host computer operating system or through a control display located on the memory device.

10. The computer or electronics system of claim 9 wherein the device or hub function in a disconnected mode to perform one or more management actions on the information stored in the memory device when the device is not connected to a computer system.

11. The computer or electronics system of claim 9 wherein a profile is selected by use of a list or menu accessed through the user interface or the memory device control display.

12. The computer or electronics system of claim 9 wherein the management actions performed on the data stored in the memory device are selected from a group comprised of encryption, erasure, downloading, printing, synchronization, viewing labels and viewing storage capacity.

13. A method of using a computer or electronics system comprised of the following components acting in cooperation with each other to carry out the following steps in presenting one or more programmable data profiles that identify and categorize at least some of the information stored in a memory device for selection by a user of the device:
(a). using at least one removable portable memory device to store one or more profiles that have been customized for use with the device and are identified by a user or data type; and
(b). using at least one control to present one or more user-selectable actions or default actions to be performed by the memory device on the information defined by the profile;
wherein a user selects one or more profiles to perform ensuing management actions on the information defined by each selected profile.

14. A method of using the computer or electronics system of claim 13 further comprising use of a hub configured for connecting the memory device to a host computer system through use of a software interface acting in cooperation with the host computer and the hub and the memory device to provide one or more management functions for input, storage, display or retrieval of data or profiles as well as profile selection and initiation of profile actions by the user.

15. A method of using the computer or electronics system of claim 14 further comprised of using a software application configured for:
(a). creation of one or more selectable programmable data profiles that identify and categorize at least some of the information stored in the memory device; and
(b). selection of a profile by access through a user interface of a host computer operating system or through a control display located on the memory device.

16. A method of using the computer or electronics system of claim 15 wherein the device or hub function in a disconnected mode to perform one or more management actions on the information stored in the memory device when the device is not connected to a computer system.

17. A method of using the computer or electronics system of claim 15 wherein a profile is selected by use of a list or menu accessed through the user interface or the memory device control display.

18. A method of using the computer or electronics system of claim 15 wherein the management actions performed on the data stored in the memory device are selected from a group comprised of encryption, erasure, downloading, printing, synchronization, viewing labels and viewing storage capacity.
